(19) United States
(12) Patent Application Publication
(10) Pub. No.: US 2018/0210152 A1
(43) Pub. Date: Jul. 26, 2018

(54) Armordillo Fiber Optic Splice On Connector

(71) Applicants: Frank Giotto, New Hartford, NY (US); Raymond Wertz, New York Mills, NY (US); Rina Sou, Utica, NY (US)

(72) Inventors: Frank Giotto, New Hartford, NY (US); Raymond Wertz, New York Mills, NY (US); Rina Sou, Utica, NY (US)

(21) Appl. No.: 15/415,028

(22) Filed: Jan. 25, 2017

(51) Int. Cl. G02B 6/38; G02B 6/44

(52) U.S. Cl. CPC G02B 6/3801; G02B 6/4471

(57) ABSTRACT

This invention relates to a method of splicing fiber optic fiber and the protection needed to secure that splice. This invention presents a quick and reliable way for fiber technicians to create sturdy splices that exceed the strength of splices currently in use. It utilizes an inner and outer strength member that is new to the field of fiber optics. These strength members include an inner steel rod, housed within an inner shrink tube, which is thereby housed within an outer shrink tube. Once melted, this tube is slid inside of a brass crimp sleeve which provides sturdy protection for the spliced fiber.

### BRIEF DESCRIPTION OF THE DRAWINGS

A complete understanding of the present invention may be obtained by reference to the accompanying drawings, when considered in conjunction with the subsequent, detailed description, in which:

### DETAILED DESCRIPTION

The present invention solves the issue of easily fusion splicing an SOC connector to 2 mm to 3 mm cable. The increased ruggedness of the completed connector results in a shorter boot length using fewer parts.

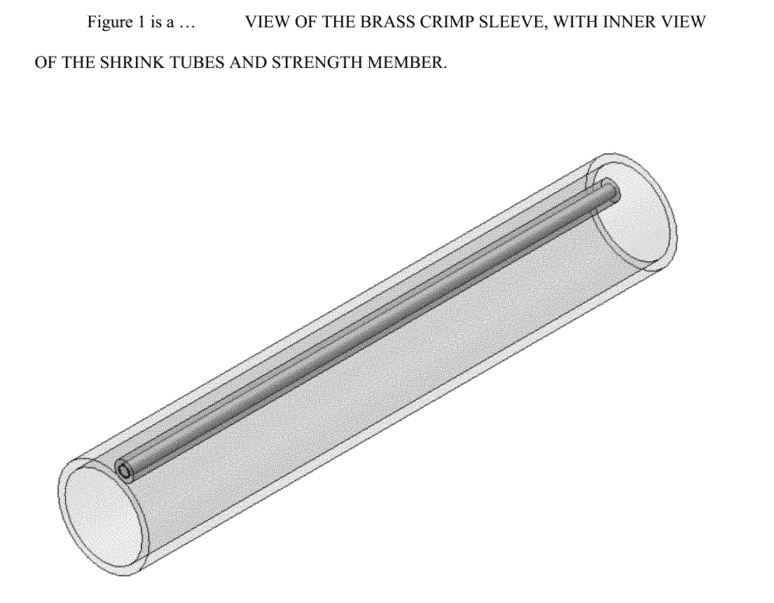

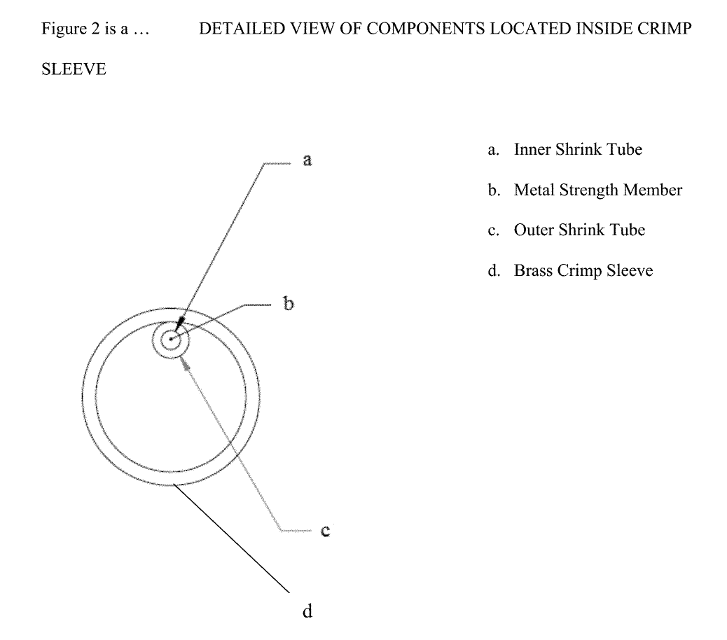

The current methods for splice protection include the assembled standard fusion splice sleeve which internally contains the metal strength member. Currently, the accepted method of splice protection is utilizing two assembled heat sensitive tubes supported by a stainless steel rod. It is made up of an outer tube that is a shrink tube, an inner tube which houses the fiber, and a strength member made up of a small steel rod which is housed between the inner and outer tubes, as pictured in FIGS. 1 and 2. The shrink tube is installed over the splice using a heat gun or a protection sleeve oven. These protection sleeves provide stability for the spliced optical fibers. The steel rod prevents the spliced area from bending or flexing. In this invention, a brass crimp sleeve is then slid over the spliced area and shrink tubes, and crimped at both ends. A plastic boot is slid over the spliced area for additional support and strain relief. In this current invention, an external brass shell provides the additional protection.

The current method results in a splice sleeve that is too long, resulting in an extended boot size.

The current method utilizes too many parts.

The current method does not provide for protection that is as strong as the new invention.

The present invention increases the rigidity of the internal strength member with the use of the brass external crimp sleeve, as seen in FIGS. 1 and 2. It is critical to the field technician installing an SOC that the procedure is intuitive and results in a robust connection.

The present embodiment of this invention moves the strength member to the exterior of the optical fiber splice, as seen with the outer location of the brass crimp sleeve in FIGS. 1 and 2, something not seen in the fiber optics industry.

Performing a traditional splice, protected by the traditional splice sleeve, requires the sliding of the 45 mm protection sleeve over the splice, thus requiring 90 mm or more of bare fiber, which must later be protected by a connector boot. The total length of this construction is unacceptable in a splice on connector and the resulting is less robust than the traditional epoxy installed connector.

This present invention uses a larger shrink tube that slides over 2-3 mm jacket reducing nearly in half the length of bare fiber required. The use of the adhesive tube and inner tube with strength member enables a technique that the traditional splice sleeve does not allow. The externally crimped brass sleeve to jacket and Kevlar provides never before provided strength.

### SPECIFICATION OF DRAWINGS

FIG. 1 . . . is an image displaying the components used to create a stronger splice on connector to protect spliced optical fiber. This image contains the brass crimp sleeve, an outer shrink tube, an inner shrink tube (both known as protection sleeves), and a metal strength member which creates additional strength within the splice next to the fiber. The shrink tube is utilized first, and is slid over the spliced fiber area. The outer shrink tube houses the inner shrink tube with metal strength member, as well as the fiber. Once the protection sleeves are melted over the fiber using a splice on connector oven, the brass crimp sleeve is slid over the spliced fiber area and crimped to the connector on one end, and crimped at the other to hold the splice. A plastic boot, not shown, is slid over the crimp sleeve for additional support.

FIG. 2 . . . is a detailed image of the components within the brass crimp sleeve. This further displays how the inner shrink tube, metal strength member, and outer shrink tube are housed within the brass crimp sleeve.

### BRIEF SUMMARY

In accordance with the present invention, there is provided . . . a Splice on Connector (SOC) capable of handling 2 to 3 mm jacketed fiber cable, a brass tube, or tube of another sturdy metal, of a length sufficient to cover the spliced area, an outer adhesive shrink tube, and an inner shrink tube containing a metal strength member rod. After the splice is complete, the shrink tube and adhesive tube with the strength member is placed over the splice and shrunk providing added environmental protection. The adhesive within the shrink tube replaces the removed acrylite coating that was stripped from the fiber, restoring some protection. The cable is crimped under each end of this brass tube or sleeve, providing a sturdy and durable outer protection sleeve for the optical fiber splice. The brass tube is crimped strategically on the connector side first, protecting the spliced fiber from pulling backwards away from the connector side, potentially causing damage to the splice. The fiber side of the tube is crimped second providing a tight closure of the crimp sleeve around the spliced fiber. A fitted boot is then slid up over the brass crimp sleeve to the base of the connector and crimped.

It would be advantageous to provide . . . a 2 mm to 3 mm cable SOC protective sheath that is external, not internal to the splice protection sleeve, providing increased splice protection.

It would also be advantageous to provide . . . a short protective sleeve of only 40-45 mm so that a shorter connector boot may be utilized.

It would further be advantageous to provide . . . a shrink tube with adhesive tube that will act as an initial protective layer for the spliced fiber, utilizing the adhesive to replace removed fiber acrylite.

It would also be advantageous to provide . . . a brass tube that is slid over the spliced fiber, aramid yarn, and shrink tube which can be securely crimped on both the fiber end and the connector end so as to create an immoveable enclosure over the optical fiber.

It would also be advantageous to provide . . . a way to capture the cable's aramid yarn on both ends of the splice under the crimp sleeve to improve the connector's ruggedness.

It would further be advantageous to provide . . . an order of crimping the brass sleeve at the connector side first, as this will allow the fiber to flow smoothly through the end of the brass sleeve to receive the second crimp at the cable side, generating the least likely chance that the fiber will be loose or move within the brass sleeve.

It would also be advantageous to provide . . . a 2 mm to 3 mm cable SOC that requires decreased breakout length for the splice to enable a shorter brass sleeve and connector boot.

It would also be advantageous to provide . . . a 2 mm to 3 mm cable SOC that possesses increased splice strength, increase pull strength, and increased strain relief.

It would also be advantageous to provide . . . a 2 mm to 3 mm cable SOC that improves upon GR326 Testing parameters.

It would further be advantageous to provide . . . a 2 mm to 3 mm cable SOC procedure that is faster and uses fewer parts.

### FIELD AND BACKGROUND

The present invention relates generally to the field of fiber optic cables and connectors and, more particularly, to a fiber optic splice on connector that utilizes a sturdy brass crimp sleeve, or of another sturdy metal, allowing for the spliced fiber to be protected by a stronger external housing, engineered differently than the average and currently used splice sleeve, providing increased pull strength and increased strain relief, while enabling a desired shorter splice length.

The present invention is directed to splice-on connectors for optical fiber communications, and to the technique and materials used in splicing the fiber cable to a connector holding a short length of fiber, thus joining the two into one continuous length.

Splicing is the joining of two optical fibers by melting them together to create a continuous fiber, or more specifically in this case, to join an optical fiber to an optical fiber connector. The splicing of fiber is completed in different ways, the current practice being utilizing a fusion splicer which precisely aligns the fiber ends for the splice, and melts the fiber together at a high temperature forming one continuous strand of optical fiber. This spliced fiber is very delicate, and needs to be reinforced so the fiber can be utilized for its purpose. While the present method of protecting this splice is effective, utilizing a protective assembled sheath comprised of shrink tubes with a stainless steel rod, covered by a brass crimp sleeve, covered by a boot, the strength of protection can be improved upon greatly, capturing the splice in a shorter housing, reducing the length of the required boot.

Optical fiber is used in a variety of environments, some of which may be hazardous to the delicate nature of the fiber. Optical fiber is rolled out, pulled through ducts, buried underground, and even run over by large trucks and other vehicles. The splice holding the connector to the fiber must be strong enough to withstand these environmental hazards. Operators in the field also need to be able to perform splices under varying conditions. These field locations range from office buildings, to stadiums, to military operations. The splice needs to be completed quickly and easily in each of these scenarios, and provide a secure housing for the fragile spliced optical fiber.

Accordingly, it is the object of this invention to provide a splice protection method that surpasses the strength and durability of any currently utilized methods, in a manner that is suitable for all install environments. This proposed design also embodies a decreased splice length, meaning a shorter boot length is needed, enabling the connection to be placed in standard size interconnect boxes. When splicing connectors to 2 mm to 3 mm jacketed fiber cable the present technology requires longer than standard connector boots, often forcing the user to use a less robust 900 micron jacketed fiber cable. And, the ease of which this splice and protection method is completed far surpasses any current method.

What is claimed is:

1. A method of fusion splice protection that is more durable than currently utilized splice protection in the fiber optic field.

2. A method of fusion splice protection in claim 1, whereas with this embodiment the fusion splice receives initial protection from an outer adhesive shrink tube.

3. A method of fusion splice protection in claim 1, whereas the outer adhesive shrink tube in claim 2 contains an internal tube with a metal strength member, which is then melted over the spliced fiber using a heat gun or protection sleeve oven. The spliced fiber and aramid yarn or other strength member from the fiber is housed within the inner shrink tube with the metal strength member.

4. A method of fusion splice protection in claim 1, whereas a brass crimp sleeve is slid over the cured shrink tube housing the spliced area of fiber, as in claim 3, along with the aramid yarn strength member from the fiber.

5. A method of fusion splice protection in claim 1, whereas the brass tube in claim 4 is securely crimped on the side next to the connector first using a cleaver; followed by crimping the brass tube on the back end of the tube farthest from the connector.

6. A method of fusion splice protection in claim 1, where as the crimped brass tube as in claim 5 is then further protected by sliding a fitted boot over the crimped brass tube to the base of the connector, and crimping the end of the boot for the final stage of protection.
